(19) United States
(12) Patent Application Publication
(10) Pub. No.: US 2018/0171424 A1
(43) Pub. Date: Jun. 21, 2018

(54) DEFORMATION-HARDENED COMPONENT MADE OF GALVANIZED STEEL, PRODUCTION METHOD THEREFOR AND METHOD FOR PRODUCING A STEEL STRIP SUITABLE FOR THE DEFORMATION-HARDENING OF COMPONENTS

(71) Applicant: SALZGITTER FLACHSTAHL GMBH, 38239 Salzgitter (DE)

(72) Inventors: MICHAEL BRAUN, Lehre (DE); FRIEDRICH LUTHER, Gehrden (DE); MANUEL MAIKRANZ-VALENTIN, Baunatal (DE)

(73) Assignee: SALZGITTER FLACHSTAHL GMBH, 38239 Salzgitter (DE)

(21) Appl. No.: 15/579,089

(22) PCT Filed: May 31, 2016
(86) PCT No.: PCT/EP2016/062284

§ 371 Date: Dec. 1, 2017

(30) Foreign Application Priority Data
Jun. 3, 2015 (DE) 10 2015 108 830.4
Jun. 24, 2015 (DE) 10 2015 110 164.5

(51) Int. Cl. C21D 8/10; C23C 2/28; C22C 38/06; C22C 38/04; C22C 38/02; B32B 15/01

(52) U.S. Cl. CPC C21D 8/105; C23C 2/28; C22C 38/06; C21D 9/08; C22C 38/02; B32B 15/013; C21D 2211/008; C22C 38/04

(57) ABSTRACT

A deformation-hardened component is made of galvanized steel by cutting a plate from a steel strip or steel sheet coated with zinc or with a zinc-based alloy and subsequently heating the plate to a deformation temperature above Ac3 for deformation and hardening. The galvanized steel has an at least partially martensitic transformation structure and includes as a chemical composition in wt. % C: 0.10-0.50, Si: 0.01-0.50, Mn: 0.50-2.50, P<0.02, S<0.01, N<0.01, Al: 0.015-0.100, B<0.004, remainder iron, including unavoidable smelting-induced, steel-accompanying elements. The chemical composition further includes at least one element selected from the group consisting of Nb, V, Ti, with a sum of the contents Nb+V+Ti being in a range of 0.01 to 0.20 wt. %. The structure of the steel after deformation-hardening has an average grain size of the former austenite grains of <15 μm.

The invention relates to a deformation-hardened component made of galvanized steel, a method for the production of a steel strip suitable for the deformation-hardening of components and a method for the production of a deformation-hardened component from this steel strip.

In particular, in addition to the known press-hardening of metal sheets, the term deformation-hardening should be understood hereinunder to also mean the hot-deformation and hardening of pipes, in particular internal high-pressure deformation and bending deformation with and without corresponding deformation tools.

It is known that hot-deformed, in particular press-hardened, steel sheets are being used with increasing frequency in automobile construction. By the press-hardening process it is possible to produce high-strength components which are predominantly used in the bodywork sector. Press-hardening can fundamentally be carried out by means of two different method variations, namely by means of a direct or indirect method. In this case, plates are first cut from a steel strip or steel sheet and are then further processed to make a component.

In the direct method, a steel sheet plate is heated above the so-called austenitization temperature, the thus heated plate is then transferred to a forming tool and deformed in a single-stage deformation step to make a finished component and at the same time is cooled by the cooled forming tool at a rate above the critical hardening rate of the steel so that a hardened component is produced.

In the indirect method, the plate is first deformed in a deformation process to make a component close to the final dimensions, and is cut. This component is then heated to a temperature above the austenitization temperature and transferred and inserted into a forming tool which has the final dimensions. After the cooled tool is closed the pre-formed component is cooled in this tool at a rate above the critical hardening rate and is thereby hardened.

Known hot-deformable steels for this area of application are e.g. the manganese-boron steel “22MnB5” and latterly also air-hardenable steels according to the laid-open document DE 10 2010 024 664 A1.

In addition to uncoated steel sheets, the automobile industry is increasingly also demanding and using steel sheets with scaling protection for press-hardening, these steel sheets at the same time offering corrosion protection during later use of the component. The advantages thereof are that, in addition to the increased corrosion resistance of the finished component, the plates or components do not ignite in the furnace, whereby wearing of the pressing tools by flaked-off scales is reduced.

In press-hardening, coatings are currently being used which are applied by hot-dipping and are made of aluminium-silicon (AS), zinc-aluminium (Z), zinc-aluminium-iron (ZF/galvannealed), zinc-magnesium-aluminium-iron (ZM) and electrolytically deposited coatings of zinc or zinc-nickel which can be converted to an iron-zinc alloy layer prior to the hot-deformation. These anti-corrosion coatings are conventionally applied to the hot or cold strip in continuous feed-through processes.

The advantage of zinc-based anti-corrosion coatings is that they not only comprise a barrier effect like aluminium-based coatings but can additionally offer active cathodic corrosion protection for the component.

The press-hardening of steel sheet plates with zinc-based coatings is known from DE 601 19 826 T2. In this case, a sheet plate previously heated above the austenitization temperature to 800-1200° C. and possibly provided with a metallic coating of zinc or based on zinc is deformed in an occasionally cooled tool by hot-deformation to form a component, wherein during the deformation, by reason of rapid heat extraction, the sheet or component in the deformation tool undergoes quench-hardening (press-hardening) and obtains the required strength properties owing to the resulting martensitic hardness structure.

However, zinc-based systems also have a disadvantage. Thus, in particular in the case of direct press-hardening of zinc-based anti-corrosion coatings it is known that during the deformation step micro-cracks (>100 μm) can occur in the steel in the region close to the surface and even reach partially through the cross-section of the sheet. From the literature it is known that even relatively small micro-cracks (10 μm to 100 μm) can lower the fatigue strength of the component and thereby prevent use thereof. Micro-cracks of less than 10 μm are generally considered not to be damaging.

The cause of the occurrence of micro-cracks is molten metal-induced stress crack corrosion which is also referred to as molten metal embrittlement, liquid metal assisted cracking (LMAC) or liquid metal embrittlement (LME). In this case, the austenitic grain boundaries of the steel are infiltrated and weakened by molten zinc phases, which can lead to deep cracks especially in regions under high stresses or degrees of deformation.

One way of avoiding this is the method described in patent document DE10 2010 056 265 B3 for production of a hardened steel component with a coating made of zinc or a zinc alloy, wherein, depending on the thickness of the zinc layer or the thickness of the zinc alloy layer prior to deformation, the plate is kept at a temperature of above 782° C. so long that, between the steel and the coating made of zinc or a zinc alloy, a barrier layer of zinc ferrite is formed and the zinc ferrite layer being formed receives molten zinc and is thus formed so thickly that during deformation no molten zinc phases react with the steel.

Zinc ferrite is understood in this case to be an iron-zinc mixed crystal in which the zinc atoms are present substitutionally dissolved in the iron crystal lattice. By reason of the low zinc content, the melting point of the zinc ferrite is above the deformation temperature. A further possibility is the method described in EP 2 414 562 B1 for the production of a hardened steel component, wherein a single-phase zinc-nickel alloy layer consisting of [gamma-]ZnNi phase is electrolytically deposited on the flat steel product, said zinc-nickel alloy layer containing, in addition to zinc and unavoidable impurities, 7 to 15 wt. % nickel, a plate formed from the flat steel product is heated to a plate temperature amounting to at least 800° C. and is then formed in a forming tool and cooled at a rate sufficient to form the heat-treatment or hardness structure.

By reason of the nickel content the melting point of the alloy layer is increased in such a way that during the hot-deformation no molten zinc phase and therefore no molten metal embrittlement can occur. However, the method has the disadvantage that some processors/customers refuse from using it. They justify this by the intention to operate with nickel-free processes and products to the greatest extent possible.

In addition, during press-hardening in zones with unfavourable loading conditions, e.g. in the edge region of components, micro-cracks can occur which, starting from the zinc coating, extend deep into the substrate and can impair the fatigue strength of the component in the case of larger crack depths. Micro-cracks can also arise without the presence of molten zinc phases. In this case, the tip of the crack is weakened by inwardly diffusing zinc atoms.

One possibility for avoidance of micro-cracks of >10 μm is the use of indirect press-hardening in the case of zinc-based coatings since in this case the actual deformation step is carried out prior to hardening at ambient temperatures. Although during hardening and residual forming in the tool cracks likewise occur, the depth thereof is clearly less compared with the cracks in the case of direct processing.

However, the indirect method is considerably more complex since on the one hand an additional working step is required (cold-deformation) and on the other hand special furnaces must be used for heating purposes, in which components instead of plates can be heated prior to hardening.

Finally, DE 10 2013 100 682 B3 describes a method for avoiding micro-cracks in which the heated plate is subjected to an intermediate cooling step prior to press-hardening. This method is very complex since an additional manufacturing step must be implemented in the production process.

Furthermore, from laid-open documents WO 2012 028 224 A1, WO 2010 069 588 A1, WO 2005 021 821 A1 and DE 102 46 614 A1 galvanized steels for the production of press-hardened components are already known. In laid-open document JP 2006 152 427 A further steels for the production of high-strength press-hardened components are described, the structure of which after the press-hardening consists predominantly of martensite with a grain size of the former austenite grains of less than 10 μm. Furthermore, from laid-open document WO 2009 082 091 A1 a hot-rolled steel sheet with excellent hot-deformation properties and high strength is known. A grain-refining effect in addition to an improvement in toughness is also attributed to the alloy elements Nb, Ti and V.

The object of the invention is to provide a deformation-hardened component of galvanized steel which is inexpensive to produce and in which micro-cracks of >10 μm after deformation-hardening are avoided to the greatest possible extent. Furthermore, a method for the production of a steel strip suitable for the deformation-hardening of components and a method for the production of a deformation-hardened component from this steel strip is to be provided.

According to the teaching of the invention this object is achieved by a deformation-hardened component of galvanized steel in which firstly a plate is cut from a steel strip or steel sheet coated with zinc or with a zinc-based alloy, then the plate is heated to a deformation temperature above Ac3 and deformed and thus hardened, comprising an at least partially martensitic transformation structure after forming, wherein the steel has the following chemical composition in wt. %
C: 0.10-0.50
Si: 0.01-0.50
Mn: 0.50-2.50
P<0.02
S<0.01
N<0.01
Al: 0.015-0.100
B<0.004 remainder iron, including unavoidable smelting-induced, steel-accompanying elements, having at least one element from the group Nb, V, Ti, wherein the total of the contents of Nb+V+Ti is in a range of 0.01 to 0.20 wt. % and wherein the structure of the steel after deformation-hardening comprises an average grain size of the former austenite grains of less than 15 μm.

Surprisingly it has been discovered by trials that by using plates with the stated alloy composition in combination with the establishment of an extremely fine-grained structure, micro-cracks could be drastically reduced or even prevented during deformation-hardening. In relation to this, the addition of micro-alloy elements from the group of niobium, titanium and vanadium in the stated amounts and the resulting controlled establishment of a very fine-grained structure during production of the steel strip has a decisive role. If a structure with a grain size of the former austenite grains of less than 15 μm is established, the inclination to form micro-cracks is drastically reduced. The result is even clearer when grain sizes of less than 12 μm or less than 9 μm are established.

The establishment of a very fine-grained structure is assumed to prevent or markedly reduce the introduction of cracks and the progression of cracks. Furthermore, the addition of niobium, vanadium or titanium increases the grain boundary cohesion of the austenite grains, which is likewise assumed to have a positive effect on the avoidance of crack formation during deformation-hardening.

In a preferred alloy composition, the steel has a C content of 0.20 to 0.40 wt. %, an Si content of 0.15 to 0.25 wt. %, an Al content of 0.015 to 0.04 wt. %, wherein the total of the contents of Nb+V+Ti is in a range of 0.03 to 0.15 wt. %.

In order to achieve the desired effects with respect to the most fine-grained structure possible the steel has an Nb content of greater than 0.03 to less than or equal to 0.08 wt. % and/or a V content of 0.03% to 0.08 wt. % and/or a Ti content of greater than 0.09 to less than or equal to 0.2 wt. %.

In terms of process technology, the invention for the production of a steel strip suitable for the deformation-hardening of components is carried out by the following steps:

smelting of a steel with the following chemical composition in wt. %
C: 0.10-0.50
Si: 0.01-0.50
Mn: 0.50-2.50
P<0.02
S<0.01
N<0.01
Al: 0.015-0.100
B<0.004
   remainder iron, including unavoidable smelting-induced, steel-accompanying elements, having at least one element from the group Nb, V, Ti, wherein the sum of the contents of Nb+V+Ti is in a range of 0.01 to 0.20 wt. %,
   casting of the steel using a continuous casting method to form individual slabs with subsequent cooling in static air,
   reheating of the slabs to a temperature in the range of 1200° C. to 1280° C.—the dwell time at over 1200° C. must be a minimum of 30 minutes,—
   hot-rolling of the reheated slabs at a final rolling temperature in the range of 780° C. to 920° C.,
   winding of the hot strip at a winder temperature in the range of 630° C. to 750° C.,
   optional cold-rolling of the hot strip with subsequent optional recrystallisation annealing,
   coating of the hot-rolled or cold-rolled strip with zinc or a zinc-based alloy,
   optional heat treatment for the transfer of the zinc coating or zinc alloy coating into a zinc-iron alloy layer.

It has been recognised in accordance with the invention that the carbide-forming micro-alloy elements, such as niobium carbide, must undergo sufficient dissolution from the preceding continuous casting process to form fine deposits at the austenite grain boundaries during hot-rolling, which deposits are then definitive for nucleation during the phase transformation and prevention of grain coarsening at high temperatures and therefore for grain fineness and cracking resistance in the subsequent deformation-hardened component.

Thus, in accordance with the invention, reheating of the slabs to a temperature in the range of 1200° C. to 1280° C. takes place. The dwell time at over 1200° C. must be at least 30 minutes.

In addition, the final rolling temperature in accordance with the invention is lowered with respect to conventional temperatures to values in a range of 780° C. to 920° C. in order to achieve a high dislocation density at the end of the hot-rolling process. During the subsequent cooling of the hot strip this leads to a high nucleation density for the phase transformation and therefore to the desired extremely fine grain size.

In accordance with the invention, the hot strip is then wound to form a coil at a winder temperature in the range of 630° C. to 750° C. This temperature range has been established in accordance with the invention since it has been recognised that, in this temperature range, the precipitation pressure for the precipitations is at its greatest.

The hot strip thus produced can then be galvanized and directly processed further to form a component or a cold-rolling step is provided upstream of the galvanization in order to produce correspondingly thin strips of e.g. less than 1.5 mm in thickness. If the hot strip has been subjected to a cold-rolling step, the cold-rolled strip can then optionally be subjected to recrystallisation annealing. This can take place in a batch-type annealing process or in a continuous annealing installation, wherein the continuous annealing can also take place during hot-dipping galvanization.

Both hot-dipping and also electrolytic galvanization are also considered as coating methods. The coating is based on zinc as the main component, wherein, however, e.g. aluminium, magnesium, nickel and iron individually or in combination can also be contained therein. Combined coatings from electrolytic deposition of e.g. nickel, iron or zinc and subsequent annealing and hot-dipping refinement are also possible. Furthermore, it is possible to produce a thin coating by deposition from the gas phase and then to refine the strip electrolytically or by hot-dipping with a coating of zinc or a zinc alloy. It is also possible to transfer the produced layers into zinc-iron alloy layers by suitable annealing treatment in order e.g. to permit shorter furnace times or inductive rapid heating during deformation-hardening. This can take place either directly after the hot-dipping process (galvannealing) or in a separate process step in the form of a batch-type or continuous annealing process.

The deformation-hardened component thus produced has an extraordinarily good level of deformability, wherein bending angles, detected in a bending test, of over 60° and even over 80° are possible, in particular when the roll-hardened cold strip has been subjected, prior to galvanization, to a recrystallizing batch-type annealing process in a temperature range of 650° C. to 700° C. and a dwell time of 24 to 72 hours.

According to requirements for corrosion protection, the thickness of the coating can amount to between 5 μm and 25 μm, wherein greater thicknesses are also possible.

Welded pipes can also be produced from the steel strip produced by the above-described method, these pipes then each being deformation-hardened to form a component. The deformation-hardening can take place e.g. during a bending process or by internal high pressure deformation.

The pipes can be in the form of welded pipes or the steel strip is deformed to form a slit pipe which is then welded along its strip edges, wherein e.g. high-frequency induction welding (HFI) or laser welding can be considered as welding processes for the production of welded pipes.

What is claimed is:

1.-12. (canceled)

13. A deformation-hardened component made of galvanized steel by cutting a plate from a steel strip or steel sheet coated with zinc or with a zinc-based alloy and subsequently heating the plate to a deformation temperature above Ac3 for deformation and hardening, said galvanized steel having an at least partially martensitic transformation structure and comprising as a chemical composition in wt. %
C: 0.10-0.50
Si: 0.01-0.50
Mn: 0.50-2.50
P: <0.02
S: <0.01
N: <0.01
Al: 0.015-0.100
B: <0.004
remainder iron, including unavoidable smelting-induced, steel-accompanying elements, wherein the chemical composition further comprises at least one element selected from the group consisting of Nb, V, Ti, with a sum of the contents Nb+V+Ti being in a range of 0.01 to 0.20 wt. %, wherein the structure of the steel after deformation-hardening comprises an average grain size of the former austenite grains of <15 μm.

14. The deformation-hardened component of claim 13, wherein the steel has a C content of 0.20 to 0.40 wt. %, an Si content of 0.15 to 0.25 wt. %, an Al content of 0.015 to 0.04 wt. %, wherein the total of the contents of Nb+V+Ti is in a range of 0.03 to 0.15 wt. %.

15. The deformation-hardened component of claim 13, wherein the steel has an Nb content of greater than 0.03 to less than or equal to 0.08 wt. % and/or a V content of 0.03 to 0.08 wt. % and/or a Ti content of greater than 0.09 to less than or equal to 0.2 wt. %.

16. The deformation-hardened component of claim 13, wherein the structure of the steel after deformation-hardening has an average grain size of former austenite grains of <12 μm.

17. The deformation-hardened component of claim 13, wherein the structure of the steel after deformation-hardening has an average grain size of former austenite grains of <9 μm.

18. The deformation-hardened component of claim 13, wherein the deformation-hardened component has a bending angle of at least 60°.

19. A method for producing a steel strip suitable for deformation-hardening of a component, said method comprising:
smelting a steel with a following chemical composition in wt. %
C: 0.10-0.50
Si: 0.01-0.50
Mn: 0.50-2.50
P: <0.02
S: <0.01
N: <0.01
Al: 0.015-0.100
B: <0.004
remainder iron, including unavoidable smelting-induced, steel-accompanying elements, wherein the chemical composition further comprises at least one element selected from the group consisting of Nb, V, Ti, with a sum of the contents of Nb+V+Ti being in a range of 0.01 to 0.20 wt. %;
casting the steel by a continuous casting process to form individual slabs with subsequent cooling in static air;
reheating the slabs to a temperature in a range of 1200° C. to 1280° C.;
hot-rolling the reheated slabs at a final rolling temperature in a range of 780° C. to 920° C. to form a hot strip;
winding the hot strip at a temperature in the range of 630° C. to 750° C.;
optional cold-rolling the hot strip with subsequent optional recrystallisation annealing;
coating the hot-rolled or cold-rolled strip with zinc or a zinc-based alloy; and
optional heat treatment to transfer the zinc coating or zinc alloy coating into a zinc-iron alloy layer.

20. The method of claim 19, wherein the steel has a C content of 0.20 to 0.40 wt. %, an Si content of 0.15 to 0.25 wt. %, an Al content of 0.015 to 0.04 wt. %, wherein the sum of the contents of Nb+V+Ti is in a range of 0.03 to 0.15 wt. %.

21. A method for producing a deformation-hardened component from a steel strip, comprising:
producing the steel strip by smelting a steel with a following chemical composition in wt. % C: 0.10-0.50, Si: 0.01-0.50, Mn: 0.50-2.50, P<0.02, S<0.01, N<0.01, Al: 0.015-0.100, B<0.004, remainder iron, including unavoidable smelting-induced, steel-accompanying elements, wherein the chemical composition further comprises at least one element selected from the group consisting of Nb, V, Ti, with a sum of the contents of Nb+V+Ti being in a range of 0.01 to 0.20 wt. %, casting the steel by a continuous casting process to form individual slabs with subsequent cooling in static air, reheating the slabs to a temperature in a range of 1200° C. to 1280° C., hot-rolling the reheated slabs at a final rolling temperature in a range of 780° C. to 920° C. to form a hot strip, winding the hot strip at a temperature in the range of 630° C. to 750° C., optional cold-rolling the hot strip with subsequent optional recrystallisation annealing; coating the hot-rolled or cold-rolled strip with zinc or a zinc-based alloy; and optional heat treatment to transfer the zinc coating or zinc alloy coating into a zinc-iron alloy layer;
deforming the steel strip to form a slit pipe;
welding the slit pipe along its strip edges; and
deformation-hardening the welded slit pipe to form a component.

22. The method of claim 21, wherein the slit pipe is welded by high-frequency induction welding (HFI) or laser welding.

23. The method of claim 21, wherein the deformation-hardening includes hot-deforming the welded slit pipe and thereby hardening the component.

24. The method of claim 23, wherein the hot-deforming is a bending or internal high pressure deformation.
